(19) United States
(12) Patent Application Publication
(10) Pub. No.: US 2025/0284029 A1
(43) Pub. Date: Sep. 11, 2025

(54) AT-BIT MECHANICAL FORMATION PROPERTY MEASUREMENTS

(71) Applicant: Schlumberger Technology Corporation, Sugar Land, TX (US)

(72) Inventors: Matthew Blyth, Sugar Land, TX (US); Anke Simone Wendt, Tananger (NO)

(21) Appl. No.: 19/070,583

(22) Filed: Mar. 5, 2025

Related U.S. Application Data
(60) Provisional application No. 63/562,282, filed on Mar. 7, 2024.

(51) Int. Cl. G01V 20/00; E21B 47/013; E21B 49/00

(52) U.S. Cl. CPC G01V 20/00; E21B 47/013; E21B 49/00; E21B 2200/20

(57) ABSTRACT

A method for estimating a mechanical property of a subterranean formation includes engaging the formation with an engagement assembly deployed on a downhole tool to make engagement measurements while rotating the downhole tool in the wellbore. The mechanical property of the formation may be estimated from the engagement measurements. The mechanical property may include a modulus, a strain profile, or a formation integrity.

### CROSS-REFERENCE TO RELATED APPLICATION(S)

The present disclosure claims priority from U.S. Provisional Appl. No. 63/562,282, filed on Mar. 7, 2024, herein incorporated by reference in its entirety.

### BACKGROUND

Wellbores may be drilled into a surface location or seabed for a variety of exploratory or extraction purposes. For example, a wellbore may be drilled to access fluids, such as liquid and gaseous hydrocarbons, stored in subterranean formations and to extract the fluids from the formations. Wellbores used to produce or extract fluids may be formed in earthen formations using earth-boring tools such as drill bits for drilling wellbores and reamers for enlarging the diameters of wellbores.

During well-construction related operations, it is critical to maintain an intact and safe wellbore. This is often achieved by replacing the extracted (drilled) volume and density of the rock by a static or dynamic fluid column that exerts axial and radial stresses in the wellbore. The axial stress of the fluid column counterbalances the vertical stress exerted previously by the rock column, and the radial stress (Hoop stress) counteracts the two principal (natural) stresses that act laterally on the wellbore. In many geological environments, natural stresses are linked to pore pressure.

Maintaining the right density of the fluid column in the wellbore is important for a number of reasons. For example, the density of the fluid column is critical for controlling influx of formation fluids and gases that can create well control issues (such as a gas kick). The fluid density can further influence formation fracturing during drilling as well as wellbore wall collapse (breakout) or material slippage along bedding planes (plane of weakness failure). Such potential events can compromise the safety and efficiency of many operational activities and are a significant contributor to Non-Productive Time (NPT). For example, the effect of kicks can range from high costs to restore the mud system to catastrophic well failures and threat of life. Induced fracturing can lead to the loss of expensive drilling fluids, loss of caprock integrity, compromised well integrity, and well control and/or hole stability issues due to the pressure reduction in the hole. Hole stability issues can lead to tight hole and stuck pipe events with the potential of loss of the Bottom Hole Assembly (BHA) and poor or failed completions.

To mitigate against these hazards rigorous operational planning and execution is supported by detailed geoscientific and geoengineering knowledge from lab data, downhole measurements, seismic, surface, and satellite sources. For example, Geomechanical Earth Modeling (such as 1D or 3D/4D MEM) is commonly used to predict and monitor rock properties, pore pressures, wellbore stresses and natural stresses as well as their change under operational conditions (including drilling, completions, cementing, testing, production, injection). MEMs may output boundaries of the conditions of the fluid column that provide safe well operations along with uncertainties of each boundary. It will be appreciated that MEMs have a corresponding degree of uncertainty based on the information used to build them. There is a need to provide improved information to MEMs, particularly regarding mechanical properties of the subterranean formations being drilled.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example drilling system for drilling an earth formation including an instrumented drill bit.

FIG. 2 depicts an example instrumented drill bit including an example at-bit engagement sensor.

FIG. 3 depicts a perspective cutaway view of the example drill bit shown on FIG. 2.

FIG. 4 depicts a drill bit including another example at-bit engagement sensor.

FIG. 5 depicts a flowchart of an example method for making engagement measurements of a subterranean formation.

FIG. 6 depicts a flow chart of an example method for evaluating a formation modulus.

FIG. 7 depicts a flow chart of an example method for evaluating formation integrity or a formation shear profile.

### SUMMARY

An example method for estimating a mechanical property of a subterranean formation includes deploying a downhole tool including an engagement assembly in a wellbore penetrating a formation, the engagement assembly including an engagement element configured to engage the formation and an engagement sensor configured to obtain engagement measurements from the engagement of the engagement element with the formation; using the engagement assembly to make engagement measurements while rotating the downhole tool in the wellbore; and estimating a mechanical property of the formation from the engagement measurements.

This summary is provided to introduce a selection of concepts that are further described below in the detailed description. This summary is not intended to identify key or essential features of the claimed subject matter, nor is it intended to be used as an aid in limiting the scope of the claimed subject matter.

### DETAILED DESCRIPTION

Methods and systems for estimating mechanical properties of a subterranean formation are disclosed. One example method includes engaging the formation with an engagement assembly deployed on a downhole tool to make engagement measurements while rotating the downhole tool in the wellbore. The mechanical property of the formation may be estimated from the engagement measurements. The mechanical property may include, for example, a modulus, a strain profile, or a formation integrity.

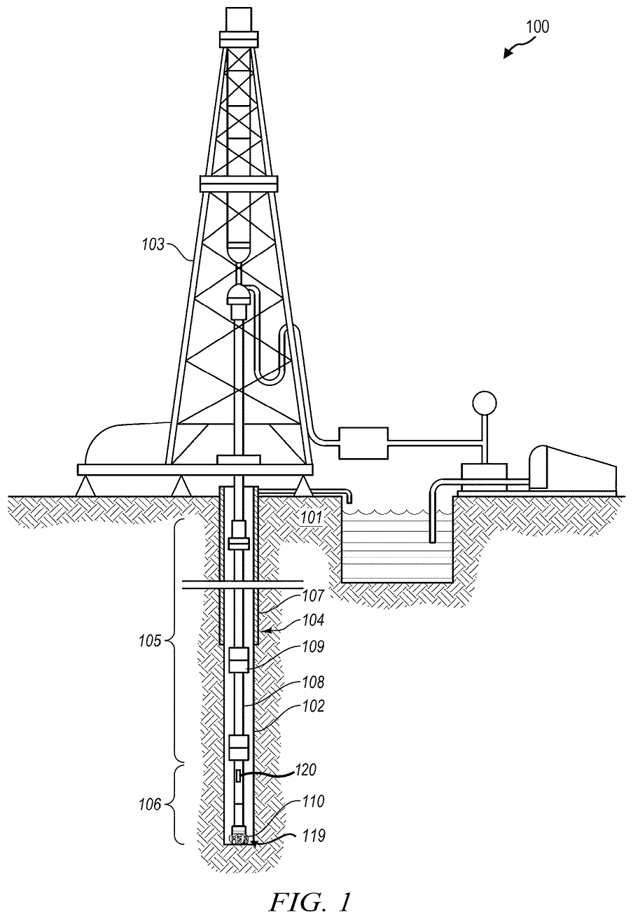

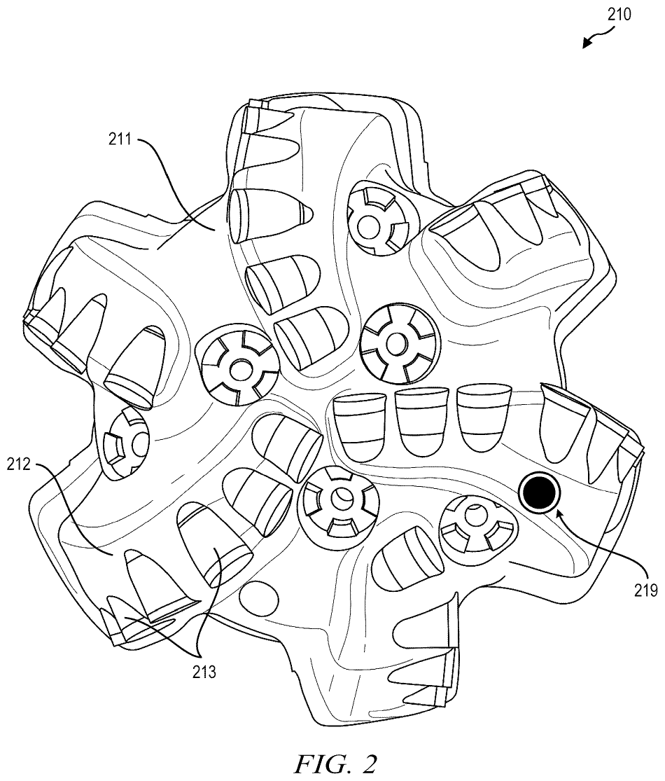

FIG. 1 depicts an example drilling system 100 for drilling a wellbore 102 in an earth formation 101. The drilling system 100 may include a drill rig 103 to turn a drilling tool assembly 104 which extends downward into the wellbore 102. The drilling tool assembly 104 may include a drill string 105, a bottomhole assembly (BHA) 106, and an instrumented drill bit 110 coupled to a downhole end of drill string 105. The instrumented drill bit 110 may include one or more engagements sensors deployed therein as described in more detail below with respect to FIGS. 2-4.

The drill string 105 may include several joints of drill pipe 108 connected end-to-end through tool joints 109 and may supply drilling fluid to the bit 110. Rotational power may also be transferred through the drill string or BHA. The BHA 106 may include the bit 110 and other optional components. An example BHA 106 may include additional or other components such as a measurement-while-drilling (MWD) tool, one or more logging-while-drilling (LWD) tools, a downhole motor, and/or a steering tool (none of which are shown). Such additional components (tools) are well known in the industry.

The drill bit 110 may be of any type suitable for degrading downhole materials and drilling the wellbore. Example types of drill bits include fixed-cutter or drag bits. In other embodiments, the bit 110 may include a mill for removing metal, composite, elastomer, and/or other materials, for example, for milling casing, plugs, cement, and/or other materials within the wellbore 102.

The instrumented drill bit 110 may include one or more instrument assemblies 119 including an engagement sensor for taking measurements (such as force or displacement) of an engagement of one or more components of the instrument assembly with the borehole. The instrument assemblies 119 may optionally be in electronic communication with an electronic controller 120 deployed elsewhere in the string, for example, in a rotary steerable tool (RSS), an LWD tool, and/or an MWD tool deployed above the drill bit 110.

FIG. 2 depicts an example instrumented drill bit 210 including an at-bit engagement sensor 219. The bit 210 may include a bit body 211 from which a plurality of blades 212 may protrude. At least one of the blades 212 may have a plurality of cutting elements 213 deployed thereon. In some embodiments, at least one of the cutting elements is a planar cutting element, such as a shear cutting element. In other embodiments, at least one of the cutting elements is a non-planar cutting element, such as a conical cutting element (e.g., Stinger cutting elements) and/or a ridged cutting element. The bit 210 further includes an instrument assembly 219 that includes instrumentation configured for making downhole measurements with the bit 210. Example assemblies 219 may include one or more sensors for measuring force, strain, pressure, temperature, or combinations thereof.

The instrument assembly 219 may include an engagement element and an engagement sensor for measuring an engagement of the engagement element with a borehole (e.g., the formation rock that makes up the borehole wall). A power supply may provide power to the engagement sensor, and a processor and memory may receive and/or record engagement measurements from the engagement sensor. In this way, the engagement element may engage the borehole, and the instrument assembly may take corresponding measurements (e.g., axial forces and/or other measurements) on the engagement element. The engagement measurements may facilitate creating or generating one or more of a graph, plot, image, or map of the parameters experienced by the bit 210 in order to illustrate one or more properties and/or features associated with the materials (e.g., of the formation) encountered by the bit 210 while drilling the borehole.

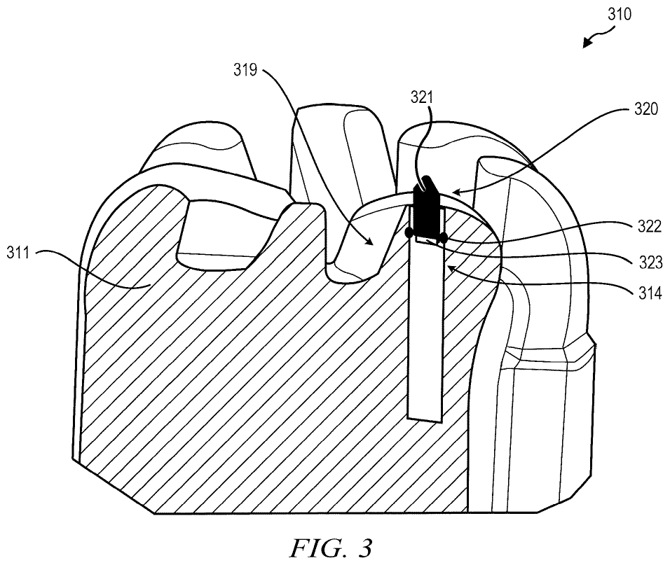

FIG. 3 depicts a perspective cutaway view of an example embodiment of the instrumented drill bit shown on FIG. 2. As described above, instrumented drill bit 310 may include an instrument assembly 319. In the depicted example, instrument assembly 319 may include an electronics housing 314 disposed in the bit body 311 and may further include instrument assembly electronics (not shown). The instrument assembly 319 may further include an engagement element assembly 320 connected to the electronics housing 314 and may facilitate incorporating electronics and/or a sensor 323 into the bit 310. For example, the electronics may be installed into the electronics housing 314 and connected to the sensor 323, after which the engagement element assembly 320 may be connected to the electronics housing 314 to complete the installation of the instrument assembly 319. While not depicted, it will be appreciated that the electronics may include electronic memory for storing the engagement measurements (the data), an electronic processor, and an electrical power supply such as a battery.

The engagement element assembly 320 may include a sensor engagement element 321 configured to engage the borehole. Example engagement elements 321 may be planar or non-planar (e.g., conical, hemispherical, bullet, etc.) and may include an ultrahard material, such as a polycrystalline diamond compact (PCD). The engagement element assembly 320 may be connected (coupled) to the electronics housing 314 such that the sensor engagement element 321 extends at least partially past an outer surface of the bit 310. For example, the sensor engagement element 321 may extend from the bit 310 such that the sensor engagement element 321 may engage the formation during drilling with the bit 310. In the depicted example embodiment, the sensor engagement element 321 may extend in a substantially vertical or axial direction (e.g., substantially downhole) to facilitate engagement of the sensor engagement element 321 with the cutting interface of the borehole (the floor).

The instrument assembly may further include an engagement sensor 323 configured to make measurements associated with the engagement of the sensor engagement element 321 with the borehole. The sensor 323 may be positioned at a base of the sensor engagement element 321. When the sensor engagement element 321 engages the borehole, a force exerted on the engagement element 321 may be transferred through the base of the sensor engagement element 321 to the sensor 323. In some embodiments, the force is an axial force. In this way, the sensor 323 may take measurements based on a force of the sensor engagement element 321. This may facilitate taking measurements associated with the formation encountered by the sensor engagement element 321. For example, geological materials in the formation may exhibit varying material properties such as hardness or modulus, which may correspond to varying measurements (e.g., forces) sensed by the sensor 323. In another example, features in the formation such as cracks or veins may correspond to varying measurements (e.g., forces) sensed by the sensor 323. The sensor 323 may measure these changes, and in this way, detect the features and/or properties of the formation.

In example embodiments, the sensor 323 may measure strain, stress, displacement, pressure, deformation, deflection or any other parameter associated with an engagement of the sensor engagement element 321 with the borehole. These measurements may facilitate calculating or determining a force on the sensor engagement element 321 or determining any other dynamic related to and engagement of the sensor engagement element 321 with the borehole. The sensor 323 may include a strain gauge, a hall effect sensor, a magnet, a capacitive sensor, a spring sensor, a piezoelectric transducer, and/or any other suitable sensor.

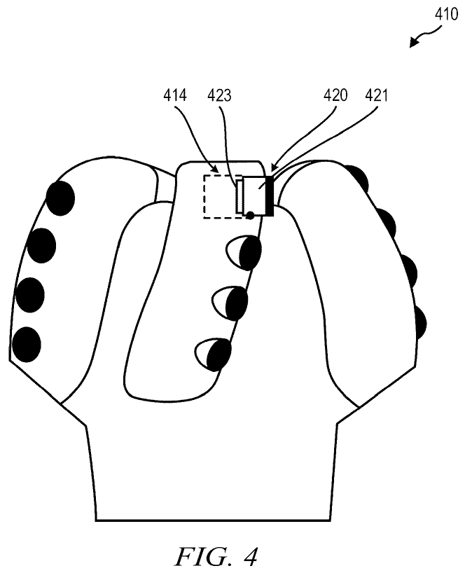

While one or more components of the instrument assembly 319 are shown in FIG. 3 as being directed or oriented in a substantially vertical or axial direction (along the axis of the drill string and borehole), it should be understood that the disclosed embodiments are not so limited. For example, in other embodiments, the sensor engagement element 321 may be oriented horizontally (in a cross axial or radial direction), as described in more detail below with respect to FIG. 4. In another example embodiment, the sensor engagement element 321 may be oriented diagonally or at any other angle relative to the axis of the drill string or wellbore. This may facilitate implementing the instrument assembly 319 in a variety of drilling tools and making both axial and cross-axial measurements.

It will be appreciated that in use, the sensor engagement element 321 may engage an earth formation in order to take one or more corresponding measurements. For example, the sensor engagement element 321 may engage the earth formation by contacting, cutting, and/or extending into the earth formation while the drill bit rotates in the borehole. This may be characterized by an engagement distance. In such embodiments, the engagement distance may correspond to a distance or the furthest extent that the sensor engagement element 321 extends into the formation upon engagement. The sensor engagement element 321 may be configured to follow the same (or a similar) rotational path as selected other cutting elements on the bit.

Turning now to FIG. 4, an instrumented drill bit 410 including another example at-bit engagement sensor 420 is depicted. In this particular example embodiment, engagement element assembly 420 and the corresponding sensor engagement element 421 are not oriented axially in the drill bit 410, but rather substantially horizontally or tangential to a rotation of the bit 410 and are deployed in a corresponding housing 414. In the depicted embodiment, the engagement element 421 is oriented tangentially. It will be appreciated that a non-axial engagement element may also be oriented radially. In use, the sensor engagement element 421 may experience a force in a horizontal or rotational direction, and the sensor 423 may measure the force. Such measured forces may facilitate determining the rotational forces exerted on the engagement elements and/or torques exerted on the bit 410. Changes in the measured force may also facilitate identifying features and properties of the formation as described in more detail below. The horizontal or rotational forces experienced by the sensor engagement element 421 may facilitate taking and/or measuring one or more parameters other than force, such as strain, stress, pressure, deformation, deflection, etc.

While the engagement assembly 420 is shown as being substantially tangentially oriented, it should be understood that the disclosed embodiments are not so limited. In other embodiments, the engagement assembly 420 may be oriented radially, for example, or at an angle relative to the radial plane of the bit 410 or at an angle from the longitudinal axis of the bit. Moreover, as described above with respect to FIG. 3, it will be appreciated that the sensor may include various electronic components, such as electronic memory for storing the engagement measurements (the data), an electronic processor, and an electrical power supply such as a battery.

With further reference to FIGS. 1-4, it will be appreciated that while the disclosed embodiments are described above with respect to an instrumented drill bit that the invention is not so limited. On the contrary, the methods described hereinbelow may be implemented using substantially any similarly instrumented downhole tool, for example, including an engagement assembly deployed on a reaming tool, a stabilizer, or a logging or measurement while drilling tool.

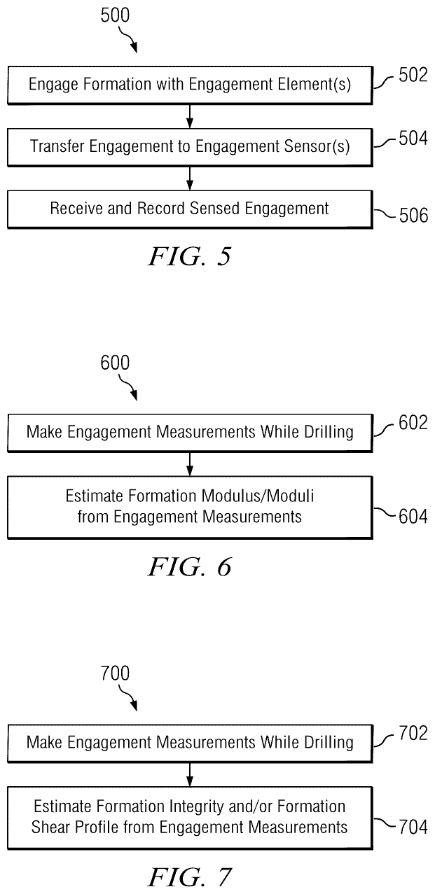

FIG. 5 depicts a flowchart of a method 500 for making engagement measurements of a subterranean formation. A drill bit (or other downhole tool) including one or more of the above described engagement assemblies may be deployed in a wellbore such that engagement element(s) engage the formation at 502, for example, during a drilling operation or reaming. For example, the engagement element may experience a force (e.g., an axial, radial, or tangential force) owing to the engagement and may transfer the force to an engagement sensor, such as a strain gauge, at 504. As described above, the engagement sensor may be positioned at the base of the engagement element and in this way may take one or more measurements associated with the force transferred through the engagement element. The engagement measurements, such as force measurements or strain measurements, may be received, for example, by a processor and electronic memory at 506.

The processor may be configured to compute various formation property values from the engagement measurements. The formation properties may include, for example, formation moduli such as Young's modulus, bulk modulus, shear modulus, and Poisson's ratio. The formation properties may also include, for example, formation integrity and formation shear profile measurements such as a three-dimensional strain profile along the length of the wellbore, a fracture compliance or fracture induction, and a confined compressive strength of the formation.

With continued reference to FIG. 5, the engagement measurements may be utilized to generate engagement images. Such images may be thought of, for example, as two dimensional contour plots of an engagement measurement (such as force or strain) versus depth (or time or number of tool revolutions) and toolface angle in the wellbore. In such embodiments, the engagement measurements may be timestamped and correlated with corresponding depth measurements and toolface measurements to generate the engagement image(s). As described above, the engagement element may experience dynamics (e.g., force, pressure, stress, displacement, etc.) due to its engagement with the borehole. These dynamics may change as the instrumented engagement element rotates with the drill bit and passes over and/or past physical features of the borehole and may be recorded with respect to the correspondingly measured toolface angle and borehole depth while drilling. Those of ordinary skill in the art will readily appreciate that high frequency toolface measurements may be made downhole, for example, using magnetometer or accelerometer measurements.

As described herein, the engagement sensor may measure a force exerted on or exhibited by the instrumented engagement element. In certain advantageous embodiments, the engagement data may include multiple different force measurements, or force measurements corresponding to multiple axes of the engagement with the earth formation. For example, as described above with respect to FIGS. 3 and 4, the engagement data may include measurements of normal forces and shear forces on the instrumented engagement element(s) (e.g., measured by multiple sensors, or a multi-axis sensor). The force measurements of the engagement data may be related or associated together, such as shear force with respect to normal force. Moreover, the engagement data may further include geometry measurements related to a geometry of the engagement element. For example, the geometry measurements may include measurements of a depth of cut into the formation and/or a groove area of an engagement element with the formation. The depth of cut may be a measure of the depth that engagement element penetrates and/or cuts into the formation, while the groove area may be a cross-sectional area of the groove that the engagement element cuts into the formation.

With continued reference to FIG. 5, the engagement data may be further correlated with other downhole measurements, such as weight on bit (WOB), drill bit torque, drill string rotation rate, rate of penetration while drilling (ROP), and the like. The engagement data may be further input into a bit rock interaction model (BRIM).

Turning now to FIG. 6, a flow chart of an example method 600 for evaluating at least one formation modulus is depicted. As described above with respect to FIG. 5, the method may include using an instrumented drill bit including one or more of the above described engagement assemblies to make engagement measurements while drilling at 602. The measurements may include, for example, force, displacement, or strain measurements and may be evaluated to estimate the formation modulus at 604. In example embodiments, the measurements may include both axial and lateral (radial) strain measurements made using corresponding axially and radially oriented engagement sensors. The measurements may be used in combination with known or estimated formation properties to invert for the axial and lateral stress. It will be appreciated when the measurements are made in an inclined wellbore they may first be rotated into an orthogonal (vertical and horizontal) reference frame.

With continued reference to FIG. 6, the measurements may include axial and radial engagement measurements from which axial and radial strains may be inferred. Measurement of the axial and radial strains may enable Poisson's ratio to be estimated, where Poisson's ratio is the ratio of the radial to axial strains (after rotation to an orthogonal reference frame). Depending on the formation compliance, near wellbore and/or far field Poisson's ratios may be estimated.

The measurements at 602 may further be evaluated to compute an elastic modulus, such as the Young's modulus which is defined as the ratio of the stress (force per unit area) applied to the formation and the resulting axial strain (displacement or deformation) in the linear elastic region. The axial strain may be derived directly from the engagement measurements at 602. The axial stress may be obtained from other measurements, stress inversion techniques, or via an inversion of the forces applied to the drill bit (e.g., WOB, ROP, torque, etc.). The Young's modulus may be computed as a ratio of the computed stress to measured strain at 604.

With still further reference to FIG. 6, the Bulk Modulus and Shear Modulus may be computed at 604 from the Young's modulus and Poisson's ratio using known relationships, for example, as follows:

$$K = \frac{E}{3 ( 1 - 2 v )}$$

$$G = \frac{E}{2 + 2 v}$$

where K represents the Bulk Modulus, G represent the Shear Modulus, E represents Young's Modulus, and v represents Poisson's ratio.

FIG. 7 depicts a flow chart of an example method 700 for evaluating formation integrity or a formation shear profile. As described above with respect to FIG. 5, the method may include using an instrumented drill bit including one or more of the above described engagement assemblies to make engagement measurements while drilling at 702. These measurements may include axial and radial measurements using corresponding axially and radially oriented engagement sensors as described above. The measurements may include, for example, force, displacement, or strain measurements and may be evaluated at 704 to estimate formation integrity or a formation shear profile.

For example, the engagement measurements made at 702 may be further evaluated to compute a confined compressive strength (CCS) of the formation. CCS is a measure of the ability of a rock sample to withstand axially directed compressive forces and may be derived from the axial force, displacement, or strain measurements. CCS may be defined as the maximum compressive stress a specimen can sustain under specified conditions until failure occurs. Moreover, the derived CCS may be compared with CCS values obtained using other methods such as compressional slowness measurements.

The measurements made at 702 may be decomposed into shear and normal strains and used to generate a continuous 3D strain profile along the length of the wellbore which may in turn be evaluated to determine the compliance (resistance to deformation or strain) of the formation along the length of the wellbore. When the tool measures material changes from ‘matrix’ to ‘natural fracture’ the stress-strain ratio provides the deformation behavior of the fracture. When the tool measures a sudden material change from unfractured to fractured (change in strain response), the fracture initiation limit may be reached. Such changes may be used, for example, to passively monitor seismic events (via fracture initiation).

Moreover, the engagement measurements may be used in combination with other measurements such as vibration monitoring and acoustic and/or ultrasonic logging. For example, it will be appreciated that the engagement measurements may induce various types of waves in the formation. These waves (and the type of wave) may depend on various factors including the properties of the rock, the design of the drill bit, and the drilling parameters. The wave types can include compressional, shear, Stoneley and transient waves, which are relevant for the calculation of the mechanical properties of the rocks in the near and the far field. These waves may be measured using various vibrational (e.g., accelerometers) and acoustic/ultrasonic logging sensors deployed in the drill string and evaluated along with the engagement measurements to compute formation properties.

With continued reference to FIGS. 6 and 7, it will be appreciated that in some embodiments the formation modulus measurements (made at 604) and the formation integrity measurements (made at 704) may be stored in downhole memory (e.g., in the sensor electronics housing) and may be further evaluated after the completion of the drilling operation. In such embodiments, the measurements may be advantageously used for subsequent completion and production planning as well as to update Geomechanical Earth Models (MEMs) described above.

In other embodiments, the formation modulus measurements and the formation integrity measurements may be transmitted to another location in the drill string in real time while drilling, such as an MWD tool. Such transmission may be accomplished, for example, via an electromagnetic transmitter deployed in the sensor electronics housing. In such embodiments, the measurements may be further evaluated, and a selection of the measurements may be further transmitted to the surface using known telemetry techniques. The measurements may then be used to assess the planned drilling operations and to update drilling operational parameters in real time. Such parameters may include, for example, drilling parameters such as weight on bit, drilling fluid parameters such as density, as well as various hole cleaning procedures used while drilling.

The disclosed embodiments may advantageously enable valuable formation properties to be measured during a drilling operation, for example, including various formation moduli and Poisson's ratio, as well as a shear profile and a confined compressive strength. As described herein, these measurements may be advantageously utilized to update MEMs that are extensively utilized in well planning activities. Moreover, the measurements may be further evaluated and considered while planning subsequent completion and production activities. In certain example embodiments in which a selected portion of the measurements are transmitted to the surface, the measurements may be evaluated in real-time while drilling the well to update or modify the well plan, to optimize or adjust various drilling parameters such as weight on bit or drilling fluid density as well as trigger additional hole cleaning or reaming operations. It will be appreciated that the disclosed embodiments are not limited to any post measurement activities, such as those described above.

As noted above, the disclosed embodiments may advantageously provide improved formation property measurements (or estimates) that may be used in the aforementioned MEMs. These models generally make a number of assumptions when data are not readily available, with the correctness of the assumptions defining the accuracy of any model prediction. The formation measurements made using the disclosed methods may obviate the need for making certain assumptions and may therefore significantly reduce model prediction uncertainty. The above described formation strain measurements may provide multiple ways to refine the accuracy of geomechanics predictions in real time while drilling at the depth of the bit, with the potential for early detect of changes. The acquired data can be used thereafter to update and improve the pre-operational geomechanical models.

The use of the instrumented engagement assemblies may advantageously provide measurements that can be used to correlate directly with the in-situ geomechanical response of the rock. In-situ rock mechanical responses can be highly valuable since they may be performed under the right (nearly natural) conditions without extracting rock to surface (e.g., via coring or evaluating cuttings). Additionally, the generated images produced from the rotating measurements may be relevant for the geomechanical interpretations in detecting fractures, layers, and significant lithological changes.

The above described engagement measurements may further be utilized to calibrate the geomechanical model(s). Such calibration may include calibrating planning models, real time drilling models, and long-term monitoring models (mechanical response to depletion and/or injection). The calibration may be performed either using the instrumented bit data as part of the model building process, or as part of the model update process during operational activities.

Still further, the engagement measurements and formation properties derived therefrom (such as the above described moduli) may complement and to some extent replace rock mechanical lab testing. Moreover, the measurements and derived properties may advantageously be available in substantially real time while drilling instead of many months after an operational undertaking. The disclosed methods may therefore help to rapidly improve real time well construction activities, and planning and monitoring models.

Although at-bit formation property measurements have been described in detail, it should be understood that various changes, substitutions and alternations can be made herein without departing from the spirit and scope of the disclosure as defined by the appended claims

What is claimed is:

1. A method for estimating a formation modulus, the method comprising:
deploying a downhole tool including an engagement assembly in a wellbore penetrating a formation, the engagement assembly including an engagement element configured to engage the formation and an engagement sensor configured to obtain engagement measurements from the engagement of the engagement element with the formation;
using the engagement assembly to make engagement measurements while rotating the downhole tool in the wellbore; and
estimating the formation modulus from the engagement measurements.

2. The method of claim 1, wherein the downhole tool is a drill bit and the engagement element engages a cutting interface of the wellbore.

3. The method of claim 1, wherein the downhole tool includes at least first and second engagement assemblies, the first engagement assembly including an engagement element aligned with an axial direction that is parallel with a wellbore axis and the second engagement assembly including an engagement element aligned with a radial or tangential direction that is perpendicular with the wellbore axis.

4. The method of claim 3, wherein the estimating further comprises estimating a Poisson's ratio of the formation from the engagement measurements.

5. The method of claim 3, wherein the modulus comprises a Bulk Modulus or a Shear Modulus.

6. The method of claim 1, wherein the modulus comprises a Young's Modulus.

7. The method of claim 1, wherein the engagement measurements comprise force, displacement, or strain measurements.

8. The method of claim 1, further comprising updating a geomechanical earth model using the estimated formation modulus.

9. A method for evaluating formation integrity or a formation shear profile, the method comprising:
deploying a downhole tool including an engagement assembly in a wellbore penetrating a formation, the engagement assembly including an engagement element configured to engage the formation and an engagement sensor configured to obtain engagement measurements from the engagement of the engagement element with the formation;
using the engagement assembly to make engagement measurements while rotating the downhole tool in the wellbore; and
estimating the formation integrity or a formation shear profile from the engagement measurements.

10. The method of claim 9, wherein the downhole tool is a drill bit and the engagement element engages a cutting interface of the wellbore.

11. The method of claim 9, wherein the downhole tool includes at least first and second engagement assemblies, the first engagement assembly including an engagement element aligned with an axial direction that is parallel with a wellbore axis and the second engagement assembly including an engagement element aligned with a radial or tangential direction that is perpendicular with the wellbore axis.

12. The method of claim 9, wherein the engagement measurements comprise force, displacement, or strain measurements.

13. The method of claim 9, wherein the estimating further comprises generating a three-dimensional strain profile along the length of the wellbore using the engagement measurements.

14. The method of claim 9, wherein the estimating the formation integrity comprises estimating a confined compressive strength of the formation.

15. The method of claim 9, further comprising updating a geomechanical earth model using the estimated formation integrity or a formation shear profile.

16. A system for estimating a mechanical property of a subterranean formation, the system comprising:
a downhole tool including a formation engagement assembly, the formation engagement assembly including an engagement element configured to engage the formation and an engagement sensor configured to obtain engagement measurements from the engagement of the engagement element with the formation; and
wherein the formation engagement assembly includes a processor configured to (i) cause the engagement sensor to make engagement measurements while the downhole tool rotates a subterranean wellbore and (ii) estimate the mechanical property of the formation from the engagement measurements.

17. The method of claim 16, wherein the downhole tool is a drill bit and the engagement element engages a cutting interface of the wellbore.

18. The method of claim 16, wherein the engagement measurements comprise strain measurements or force measurements.

19. The method of claim 16, wherein the mechanical property of the formation comprises at least one of a Poisson's ratio, a Young's Modulus, a Bulk Modulus and a Shear Modulus of the formation.

20. The method of claim 16, wherein the mechanical property of the formation comprises at least one of a three-dimensional strain profile along a length of the wellbore, a fracture compliance or fracture induction limit from the engagement measurements.
